(19) United States
(12) Patent Application Publication
(10) Pub. No.: US 2024/0165718 A1
(43) Pub. Date: May 23, 2024

(54) DRILL BIT

(71) Applicant: MILWAUKEE ELECTRIC TOOL CORPORATION, Brookfield, WI (US)

(72) Inventor: Hunter S. Karlen, Hartford, WI (US)

(21) Appl. No.: 18/512,124

(22) Filed: Nov. 17, 2023

Related U.S. Application Data
(60) Provisional application No. 63/384,111, filed on Nov. 17, 2022.

(51) Int. Cl. B23B 51/02; B23P 15/32

(52) U.S. Cl. CPC B23B 51/02; B23P 15/32

(57) ABSTRACT

A drill bit including a body, a shank, and a cutting head. The body has a first end and a second end. The shank is located at the first end. The cutting head is located at the second end. The cutting head includes a tip, a first cutting edge, and a second cutting edge. The first cutting edge extends from the tip at a first angle. The second cutting edge extends from the tip at a second angle. The second angle is different from the first angle.

### CROSS-REFERENCE TO RELATED APPLICATIONS

This application claims priority to U.S. Provisional Patent Application No. 63/384,111 filed on Nov. 17, 2022, the entire contents of which are incorporated herein by reference.

### FIELD OF THE INVENTION

The present invention relates to power tool accessories. More specifically, the present invention relates to drill bits.

### BACKGROUND

Drill bits, such as masonry drill bits, are used to drill holes into hard materials such as concrete, cinder block, stone, brick (e.g., red brick), tile, metal, wood, plastic, porcelain, ceramics and the like. Some drill bits can be used with power tools such as hammer drills and impact drills that are operable in a drilling mode which only rotates the masonry drill, a chisel mode which delivers only percussive force to the masonry drill, or a hammer drill mode which rotationally drives the masonry drill and delivers a percussive force to the masonry drill.

### SUMMARY

In one aspect, the disclosure provides a drill bit including a body, a shank, and a cutting head. The body has a first end and a second end. The shank is located at the first end. The cutting head is located at the second end. The cutting head includes a tip, a first cutting edge, and a second cutting edge. The first cutting edge extends from the tip at a first angle. The second cutting edge extends from the tip at a second angle. The second angle is different from the first angle.

In another aspect, the disclosure provides a drill bit including a body, a shank, and a cutting head. The body has a first end and a second end. The body defines an axis of rotation that extends between the first end and the second end through a center of the body. The shank is located at the first end. The cutting head is located at the second end. The cutting head includes a cutting insert that is asymmetrical on opposite sides of the axis of rotation.

In another aspect, the disclosure provides a method of manufacturing a tool bit, the method including, forming a body having a first end and a second end, forming a shank at the first end, and forming a cutting head at the second end. The cutting head has a tip, a first cutting edge extending from the tip at a first angle, and a second cutting edge extending from the tip at a second angle. The second angle is different than the first angle.

Other aspects of the invention will become apparent by consideration of the detailed description and accompanying drawings.

### BRIEF DESCRIPTION OF THE DRAWINGS

FIG. 1 is a side view of a drill bit including a cutting head according to the prior art.

FIG. 2 is an enlarged view of the cutting head according to the prior art.

FIG. 3 is a side view of a drill bit including a cutting head according to an embodiment of the disclosure.

FIG. 4 is an enlarged view of the cutting head of FIG. 3.

FIG. 5 is a table including performance data for the drill bit.

FIG. 6 is another table including performance data for the drill bit.

FIG. 7 is a flow chart illustrating a method of manufacturing the drill bit of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

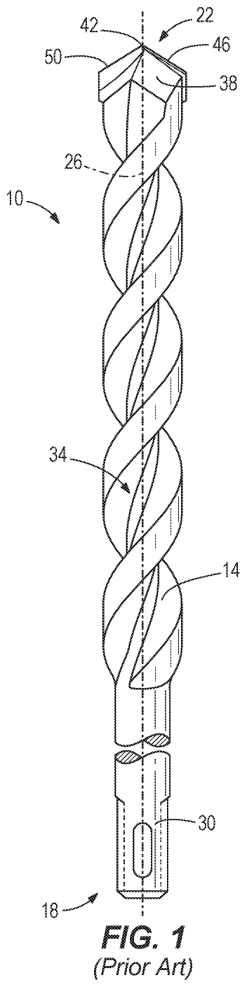

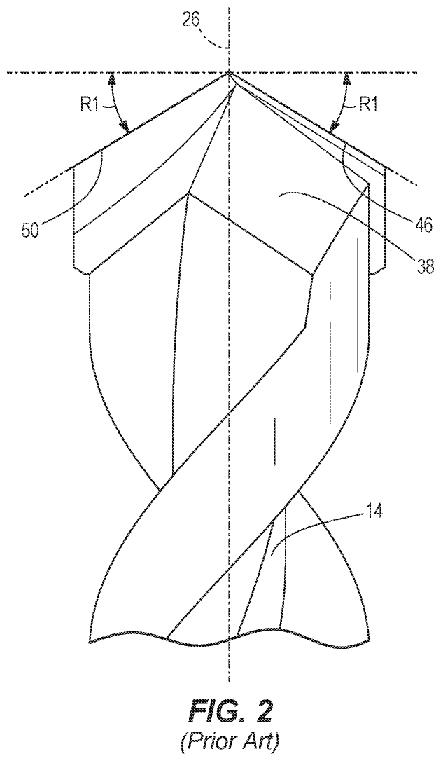

FIGS. 1 and 2 illustrate a drilling tool 10 according to the prior art. The drilling tool 10 includes a body 14 having a first end 18, a second end 22 opposite the first end 18, and an axis of rotation 26 extending between the first and second ends 18, 22. A shank 30 is positioned adjacent the first end 18. The shank 30 is operable to connect the drilling tool 10 to a power tool such as a drill or rotary hammer. The drilling tool 10 also includes a body flute 34 that extends between the first and second ends 18, 22. In the illustrated embodiment, the drilling tool 10 includes four body flutes 34. The drilling tool 10 further includes a cutting head 38 that is positioned at the second end 22 of the drilling tool 10. The cutting head 38 has a tip 42, a first cutting edge 46 that extends from the tip 42, and a second cutting edge 50 that extends from the tip 42 away from the first cutting edge 46. The second cutting edge 50 is symmetrical to the first cutting edge 46 across the axis of rotation 26. That is, the first cutting edge 46 and the second cutting edge 50 extend at the same angle R1 from the tip 42 relative to a tip axis 54 that extends tangential to the tip 42.

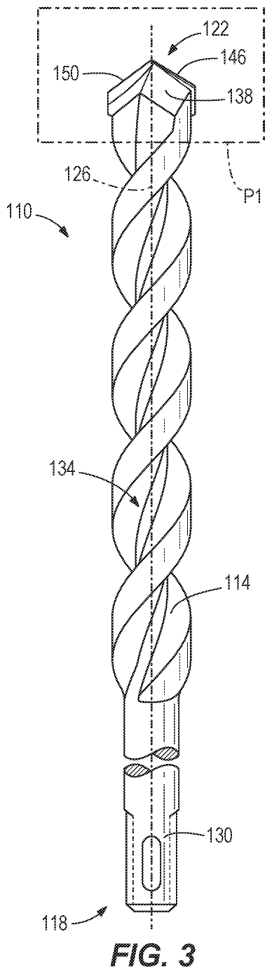

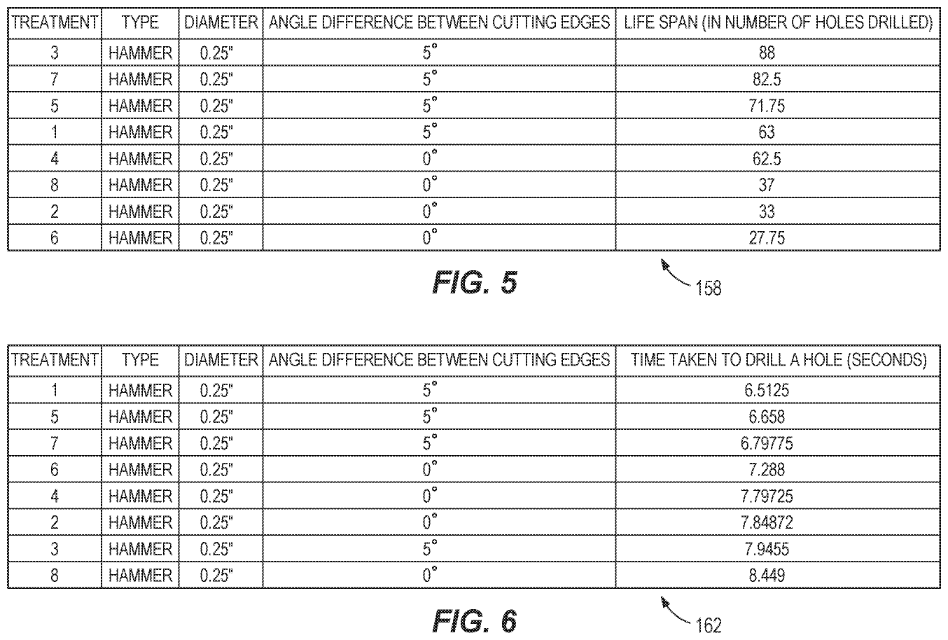

FIG. 3 illustrates a drill bit 110 according to an embodiment of the disclosure. The drill bit 110 includes a body 114 having a first end 118, a second end 122 opposite the first end 118, and an axis of rotation 126. The axis of rotation 126 extends through the first end 118 and the second end 122. Stated another way, the axis of rotation 126 extends between the first end 118 and the second end 122 through a center of the body 114. The axis of rotation 126 may also be a central longitudinal axis of the drill bit 10. The drill bit 110 further includes a shank 130, body flutes 134 that extend between the first end 118 and the second end 122, and a cutting head 138. The shank 130 is located at the first end 118 and is configured to be coupled to a power tool, such as a hammer drill or drill/driver. The illustrated shank 130 is an SDS-style shank, such as an SDS shank, an SDS Plus shank, or an SDS Max shank. In other embodiments, the shank 130 may have other configurations, such as a hex shank. The cutting head 138 is located at the second end 122 and is configured to engage a workpiece 5 (FIG. 5), such as, for example, concrete.

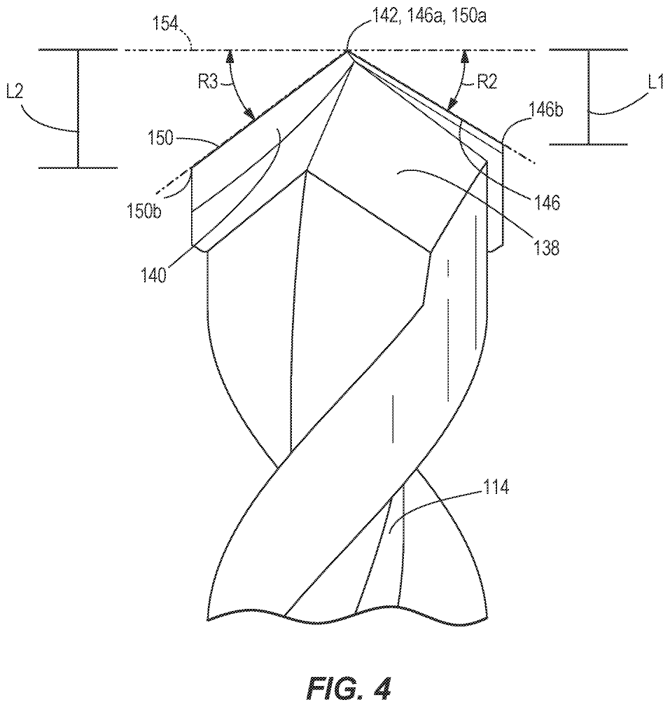

With additional reference to FIG. 4, the cutting head 138 receives a cutting insert 140 that includes a tip 142, a first cutting edge 146 that extends from the tip 142 to an outer periphery of the cutting head 138, and a second cutting edge 150 that extends from the tip 142 to an outer periphery of the cutting head 138 opposite the first cutting edge 146. In some embodiments, the first cutting edge 146 and the second cutting edge 150 extend past the outer periphery of the cutting head 138. In the illustrated embodiment the cutting head 138 receives just one cutting insert 140. For example, the cutting insert 140 may be a monolithic, plate-like member. The cutting insert 140 may also be generally trapezoidal and planar. In other embodiments, the cutting head 138 may receive a plurality of cutting inserts 140. The tip 142 defines a tip axis 154 that extends tangential to the tip 142. The tip axis 154 is also perpendicular to the axis of rotation 126 (FIG. 3). The second cutting edge 150 is asymmetrical to the first cutting edge 146 relative to the axis of rotation 126. Specifically, the first cutting edge 146 extends from the tip 142 at a first angle R2 from the tip axis 154, and the second cutting edge 150 extends from the tip 142 at a second angle R3 from the tip axis 154. As such, the cutting insert 140 is asymmetrical on opposite sides of the axis of rotation 126. Specifically, the cutting insert 140 is asymmetrical on opposite sides of the axis of rotation 126 with a plane PI (FIG. 3) including both the axis of rotation 126 and the tip axis 154.

In the illustrated embodiment, the first angle R2 and the second angle R3 are different angles. More specifically, the second angle R3 is greater than the first angle R2. As such, the second cutting edge 150 is steeper than the first cutting edge 146. As a result, at the outer periphery of the cutting head 138, the first cutting edge 146 is disposed relatively closer to the tip axis 154 than the second cutting edge 150 to the tip axis 154. In other words, the first cutting edge 146 includes a first end 146a and a second end 146b, and the second cutting edge 150 includes a first end 150a and a second end 150b. In the illustrated embodiment, the first end 146a of the first cutting edge 146 and the first end 150a of the second cutting edge 150 are coincident with the tip 142. The second end 146b of the first cutting edge 146 is positioned a first distance L1 from the tip axis 154, the second end 150b of the second cutting edge 150 is positioned a second distance L2 from the tip axis 154, and the first distance L1 is shorter than the second distance L2 such that the second end 146b of the first cutting edge 146 is positioned relatively closer to the tip axis 154 than the second end 150b of the second cutting edge 150. In some embodiments, second angle R3 is 1 to 10 degrees greater than the first angle R2. In other embodiments, the second angle R3 is 3 to 8 degrees greater than the first angle R2. In the illustrated embodiment, the second angle R3 is 3 to 5 degrees greater than the first angle R2. For example, the first angle R2 may be about 30 degrees, and the second angle R3 may be about 35 degrees. In other embodiments, the first and second angles R2, R3 may have other values.

In the illustrated embodiment, the body 114, the shank 130, and the cutting head 138 are formed together as a monolithic member. The cutting insert 140 is separately formed from the body 114, the shank 130, and the cutting head 138 and then fixed to the cutting head 138. The cutting insert 140 may be made of the same material as the cutting head 138, such as steel, or may be made of a different material than the cutting head 138, such as carbide. The cutting insert 140 may be formed from a variety of machining methods such as, but not limited to, machining, molding, and the like. In some embodiments, the cutting insert 140 may be first formed with symmetrical edges, and the second cutting edge 150 may then be later machined to adjust the angle at which the second cutting edge 150 extends from the tip 142. In other embodiments, the cutting insert 140 may be directly formed with asymmetrical cutting edges 146, 150. For example, the cutting insert 140 may be formed with an asymmetrical mold for directly forming the first cutting edge 146 and the second cutting edge 150. The cutting insert 140 is then fixed to the cutting head 138 through any fixing means such as, but not limited to, welding, brazing, adhering, and the like.

In other embodiments, the drill bit 110 may not include the cutting insert 140. In such embodiments, the first cutting edge 146 and the second cutting edge 150 may be formed directly in the cutting head 138. That is, the cutting head 138 may be formed with the first cutting edge 146 and the second cutting edge 150. For example, the drill bit 110 may be formed through machining or molding such that the first cutting edge 146 and the second cutting edge 150 are directly formed with the body 114, the shank 130, and the cutting head 138. In another example, the body 114, the shank 130, and the cutting head 138 may be first formed as a monolithic body, and then the first cutting edge 146 and the second cutting edge 150 may be formed in the cutting head 138 through a variety of machining methods such as, but not limited to, grinding, milling, and the like.

FIG. 5 is a table 158 including lifespan performance data of drill bits 110 having asymmetrical edges 146, 150 according to the above disclosure and drill bits 10 having symmetrical edges 46, 50 according to the prior art. With reference to FIGS. 4 and 5, drill bits 110 in which the difference between the second angle R3 and the first angle R2 is 5 degrees have an average lifespan of 76.3 holes drilled prior to failure. With reference to FIGS. 2 and 5, drill bits 10 in which the cutting edges 46, 50 extend at the same angle R1 from the tip 42 have an average lifespan of 40 holes drilled prior to failure. As such, providing the second cutting edge 150 with a different angle of extension from the tip 142 than the first cutting edge 146 improves the lifespan of the drill bit 110. Specifically, as calculated from the table 158 the average lifespan of the drill bit 110 having the asymmetrical edges 146, 150 is roughly 76 holes. The average lifespan of the drill bit 10 having the symmetrical edges 46, 50 is roughly 40 holes. Therefore, including asymmetrical edges 146, 150 on the cutting head 138 may nearly double the lifespan of the drill bit 110.

FIG. 6 is a table 162 including speed performance data (e.g., time taken to drill a hole) for drill bits 110 having asymmetrical edges 146, 150 according to the above disclosure and drill bits 10 having symmetrical edges 46, 50 according to the prior art. With reference to FIGS. 4 and 6, drill bits 110 in which the difference between the second angle R3 and the first angle R2 is 5 degrees take an average of 6.98 seconds to drill a hole. With reference to FIGS. 2 and 6, drill bits 10 in which the cutting edges 46, 50 extend at the same angle R1 from the tip 42 take an average of 7.85 seconds to drill a hole. As such, providing the second cutting edge 146 with a different angle of extension from the tip 142 than the first cutting edge 150 improves the drilling speed of the drill bit 110.

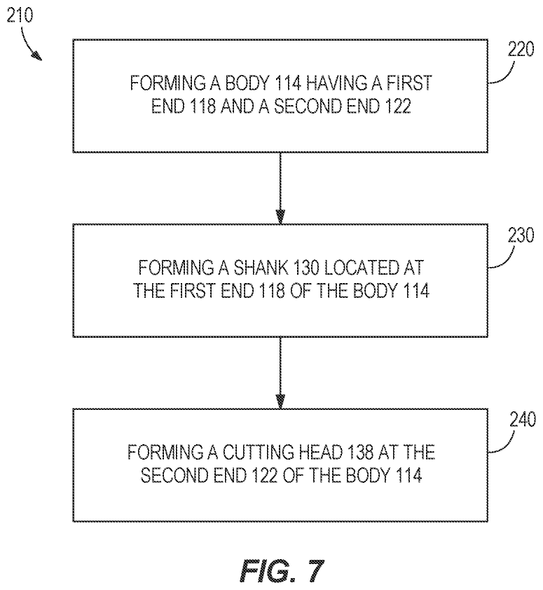

FIG. 7 illustrates a method 210 of manufacturing a drill bit 110. With reference to FIGS. 4 and 7, at step 220, the method 210 includes forming a body 114 having a first end 118 and a second end 122. The body 114 may be formed from a metal material such as bar stock. In some embodiments, the body 114 may be formed from a combination of a metal and a polymer. Body flutes 134 are formed into the body 114 and may extend between the first end 118 and the second end 122. In the illustrated embodiment, the body flutes 134 are helical. In other embodiments, the body flutes 134 may have other configurations. At step 230, the method 210 includes forming a shank 130 at the first end 118 of the body 114. In the illustrated embodiment, the shank 130 is formed from the same material as the body 114. Specifically, the shank 130 may be formed from the same piece of bar stock as the body 114 such that the body 114 and the shank 130 are formed as a monolithic member. In other embodiments, the body 114 and the shank 130 may be formed separately and fixed to one another. In such embodiments, the body 114 and the shank 130 may be formed from different materials. The shank 130 may be formed as an SDS-style shank, such as an SDS shank, and SDS Plus shank, or an SDS Max shank. In other embodiments, the shank 130 may be formed as another type of shank, such as a hex shank.

At step 240, the method 210 includes forming a cutting head 138 at the second end 122 of the body 114. In the illustrated embodiment, the cutting head 138 is formed of the same material as the shank 130 and the cutting head 138. Specifically, the cutting head 138 may be formed from the same piece of bar stock as the shank 130 and the cutting head 138 such that the body 114, the shank 130, and the cutting head 138 are formed as a monolithic member. Although the forming of the body 114, the shank 130, and the cutting head 138 are described with respect to separate steps 220, 230, 240, it is understood that the body 114, the shank 130, and the cutting head 138 may be formed simultaneously.

Forming the cutting head 138 includes forming the cutting head 138 with the tip 142, the first cutting edge 146, and the second cutting edge 150. Specifically, forming the cutting head 138 in the illustrated embodiment includes forming a cutting insert 140 having the tip 142, the first cutting edge 146, and the second cutting edge 150 separately from the cutting head 138 and fixing the cutting insert 140 to the cutting head 138. In the illustrated embodiment, the cutting insert 140 is formed of a different material than the body 114, the shank 130, and the cutting head 138. For example, the cutting insert 140 may be formed from carbide. In some embodiments, the cutting head 138 and the cutting insert 140 may be formed from the same material. In the illustrated embodiment, fixing the cutting insert 140 to the cutting head 138 occurs after the cutting head 138 is formed. In other embodiments, the cutting insert 140 may be fixed to, for example, a piece of bar stock before the body 114, the shank 130, and the cutting head 138 are formed.

The first cutting edge 146 is formed such that the first cutting edge 146 extends from the tip 142 at a first angle R2. The second cutting edge 150 is formed such that the second cutting edge 150 extends from the tip 142 at a second angle R3. The first angle R2 and the second angle R3 may differ by between 1 to 10 degrees. Specifically, in the illustrated embodiment, the angles R2, R3 differ by 5 degrees. In some embodiments, the tip 142, the first cutting edge 146, and the second cutting edge 150 may be formed directly in the cutting head 138. In such embodiments, the cutting edges 146, 150 may be initially formed at the same angle R2, R3, and the second cutting edge 150 may be machined down after the initial forming process.

Although the invention is described with reference to discrete embodiments of the drill bit 110, variations of the drill bit 110 exist within the spirit and scope of the invention. Various features and advantages of the invention are set forth in the following claims.

What is claimed is:

1. A drill bit comprising:
a body having a first end and a second end;
a shank located at the first end; and
a cutting head located at the second end, the cutting head including
a tip,
a first cutting edge extending from the tip at a first angle, and
a second cutting edge extending from the tip at a second angle, the second angle being different than the first angle.

2. The drill bit of claim 1, wherein the cutting head includes a cutting insert that is formed separately from the cutting head and is fixed to the cutting head, the cutting insert forming the tip, the first cutting edge, and the second cutting edge.

3. The drill bit of claim 2, wherein the cutting head and the cutting insert are formed of different materials.

4. The drill bit of claim 3, wherein the body, the shank, and the cutting head are formed as a monolithic body.

5. The drill bit of claim 1, wherein the tip defines a tip axis that extends tangential to the tip, wherein the first angle is defined between the first cutting edge and the tip axis, and wherein the second angle is defined between the second cutting edge and the tip axis.

6. The drill bit of claim 5, wherein the second angle differs by 1 to 10 degrees from the first angle.

7. The drill bit of claim 6, wherein the second angle is greater than the first angle.

8. The drill bit of claim 1, wherein each of the first cutting edge and the second cutting edge extends from the tip past an outer periphery of the cutting head.

9. The drill bit of claim 1, wherein the tip defines a tip axis that extends tangential to the tip axis, wherein the first cutting edge has a first end and a second end and the second cutting edge has a first end and a second end, and wherein the second end of the first cutting edge is positioned closer to the tip axis than the second end of the second cutting edge.

10. A drill bit comprising:
a body having a first end and a second end, the body defining an axis of rotation that extends between the first end and the second end through a center of the body;
a shank located at the first end; and
a cutting head located at the second end, the cutting head including a cutting insert that is asymmetrical on opposite sides of the axis of rotation.

11. The drill bit of claim 10, wherein the cutting insert includes a tip, wherein the tip defines a tip axis that extends tangential to the tip and perpendicular to the axis of rotation, and wherein the cutting insert is asymmetrical on opposite sides of the axis of rotation within a plane including both the axis of rotation and the tip axis.

12. The drill bit of claim 11, wherein the cutting head includes a first cutting edge having a first end and a second end and a second cutting edge having a first end and a second end, and wherein the second end of the first cutting edge is positioned closer to the tip axis than the second end of the second cutting edge.

13. The drill bit of claim 10, wherein the cutting insert includes a first cutting edge and a second cutting edge that are asymmetrical on opposite sides of the axis of rotation.

14. The drill bit of claim 13, wherein the body, the shank, and the cutting head are formed together as a monolithic body, and wherein the cutting insert is separately fixed to the cutting head.

15. A method for manufacturing a tool bit, the method comprising:
forming a body having a first end and a second end;
forming a shank at the first end; and
forming a cutting head at the second end, the cutting head having a tip, a first cutting edge extending from the tip at a first angle, and a second cutting edge extending from the tip at a second angle, the second angle being different than the first angle.

16. The method of claim 15, wherein forming the cutting head at the second end includes fixing a cutting insert having the tip, the first cutting edge, and the second cutting edge to the cutting head.

17. The method of claim 15, wherein forming the cutting head includes first forming each of the first cutting edge and the second cutting edge extending at the first angle and then machining the second cutting edge to extend from the tip at the second angle.

18. The method of claim 15, wherein forming the cutting head at the second end includes forming the second cutting edge such that the second angle differs by 1 to 10 degrees from the first angle.

19. The method of claim 15, wherein the body, the shank, and the cutting head are formed together as a monolithic member.

20. The method of claim 15, wherein the cutting head is formed separately and coupled to the body.
